(19) United States
(12) Patent Application Publication
(10) Pub. No.: US 2011/0099910 A1
(43) Pub. Date: May 5, 2011

(54) VEHICLE DOOR HAVING A SEALING PLANE AND HAVING A SEALING ELEMENT WHOSE ENDS OVERLAP

(75) Inventor: Thorsten Meyer, Krefeld (DE)

(73) Assignee: JOHNSON CONTROLS TECHNOLOGY COMPANY, Holland, MI (US)

(21) Appl. No.: 12/445,903

(22) PCT Filed: Oct. 18, 2007
(86) PCT No.: PCT/EP2007/009048

§ 371 Date: Dec. 9, 2010

(30) Foreign Application Priority Data
Oct. 18, 2006 (DE) 10 2006 049 679.5

(51) Int. Cl. B60J 5/04; B60J 10/08

(52) U.S. Cl. 49/475.1

(57) ABSTRACT

Proposed is a vehicle door having a sealing plane (2), wherein the sealing plane (2) separates a wet region of the vehicle door from a dry region of the vehicle door, and an elongate sealing element (3) is provided on the sealing plane (2). The ends (4, 4′) of the elongate sealing element (3) substantially overlap, wherein a functional element is guided between the overlapping ends of the elongate sealing element.

### CROSS REFERENCE TO RELATED APPLICATIONS

This application claims priority from and the benefit of PCT Application No. PCT/EP2007/009048, filed on Oct. 18, 2007; and German Patent No. DE 10 2006 049 679.5, filed on Oct. 18, 2006; both entitled “Vehicle Door Having a Sealing Plane and Having a Sealing Element Whose Ends Overlap”, which are herein incorporated by reference.

### BACKGROUND

The invention relates to a vehicle door having a sealing plane, wherein a wet region of the vehicle door is separated from a dry region of the vehicle door by the sealing plane, and the sealing plane has an elongate sealing element whose ends substantially overlap.

Vehicle doors of this type are generally known. For example, the utility model document DE 201 11904 U1 describes a sealing arrangement for a vehicle door having a longitudinally extended sealing element. In this case, the sealing element is located on a covering and the end sections of the sealing element overlap.

A disadvantage of a vehicle door of this type is that there have to be holes in the covering for a connection between a wet region of a vehicle door and the dry region of the vehicle door. Said holes or cutouts then have to be sealed again in a complicated manner. Furthermore, the production of the covering is complicated, since the holes or cutouts have to be punched out during the manufacturing of the covering, or have to be taken into consideration by means of other working steps.

### SUMMARY

It was the object of the present invention to specify a vehicle door having a sealing plane and a sealing element that does not have the disadvantages of the vehicle doors known from the prior art. Nevertheless, the vehicle door according to the invention is to be uncomplicated in construction and is to permit rapid installation.

The object is achieved by a vehicle door having a sealing plane, wherein a wet region of the vehicle door is separated from a dry region of the vehicle door by the sealing plane, and a sealing plane has an elongate sealing element. The ends of the elongate sealing element substantially overlap, with a functional element being guided between the overlapping ends of the elongate sealing element.

By means of the invention, it is advantageously possible to transfer a functional element from a wet region into a dry region without recesses or holes having to be provided for this purpose in the sealing plane. By this means, the manufacturing of the sealing plane is particularly uncomplicated, since essentially only one component has to be manufactured without further machining steps, such as, for example, the punching out of holes. Furthermore, the sealing of the cutouts or holes is unnecessary. Working time is firstly saved here, but secondly there is also no risk of defective sealing of the cutouts or holes.

A sealing plane is to be understood as meaning a component which is provided between the body of a vehicle door and the interior molding of the vehicle door. The sealing plane is preferably manufactured from a water-impermeable material and delimits the wet region of the vehicle door from a dry region.

The dry region of a vehicle door is located in the body and is that region in the vehicle door into which water can enter. The dry region of a vehicle door begins with the sealing plane and the interior molding of a vehicle door. Neither water from outside the vehicle door nor water located in the wet region is to be able to penetrate said region.

The sealing plane is particularly preferably manufactured as a continuous component. This is to be understood as meaning that the sealing plane does not have holes or cutouts, but rather is substantially composed of a continuous material. The production of the sealing plane is simplified in this case, since finishing work, such as, for example, the punching out of the holes or sanding edges of the holes does not have to take place. However, it is also conceivable that the sealing plane has small holes for fastening the sealing plane to the body and/or to the interior door molding. However, this is to be understood as meaning that said holes have a substantially smaller diameter than cutouts and holes which would be used for the leading through of a functional element. Sealing of the holes is not necessary in this case, or is associated with a substantially lower outlay than the sealing in the case of a cutout through which a cable is guided.

The functional element, which is located between the overlapping ends of the sealing element, is preferably at least one cable. A cable harness is particularly preferably located between the overlapping ends of the sealing element. It is thereby advantageously possible to transfer a cable harness which is located in the wet region into the dry region. By this means, the supply of electric devices located in the wet region is realized in a particularly uncomplicated manner. For the installation, such a cable harness can be preassembled onto the body of the vehicle door and is placed between the overlapping ends during the installation of the sealing plane.

A complicated installation, in which such a cable harness or a cable has to be guided through a hole in a sealing plane, becomes superfluous.

Furthermore, the sealing plane is preferably preassembled on the interior door molding. This further simplifies the construction of the vehicle door according to the invention, and the installation time is further reduced. For example, the sealing plane can be produced together with the interior door molding as a composite part. A composite part is to be understood here as meaning when a component consists of two different materials, for example of plastic and a decorative layer (the interior door molding and sealing plane are consequently one component). However, it is also conceivable for the sealing plane to be attached only to the interior door molding, for example by fastening means or by adhesive bonding. In the latter case, the two components (interior door molding and sealing plane) are preferably produced separately and are subsequently joined together and delivered as a preassembled component. However, it is also conceivable for the sealing plane to be a type of film which is adhesively bonded onto the interior molding.

The sealing plane preferably has elevations and depressions. By means of such a structuring of the sealing plane, it is advantageously possible to provide the sealing element and/or the cable with support on the sealing plane. Furthermore, if the sealing element is provided in an elevation or a depression, it is precisely determined where the sealing element is to run. Great differences in the running of the sealing element and therefore possible difficulties during the installation can thus be avoided.

The cable or the cable harness particularly preferably has a sealing sleeve. The sealing sleeve prevents water from passing into the dry region of the vehicle door. Depending on the selected material or thickness of the sealing sleeve, compensation of tolerances is possible, since the distance between the two overlapping ends of the sealing element may differ. The sealing sleeve together with the cable preferably has a larger diameter than the distance between the two overlapping ends of the sealing element. By slight compression of the sealing sleeve, sealing of the transition (wet to dry) is particularly effective. Preferably, the sealing sleeve can simply be pulled over the cable.

The overlapping ends of the sealing element are furthermore preferably arranged in the upper region of the vehicle door. By the upper region, the region below the side window is meant here.

A sealing element preferably consists of foamed synthetic rubber or of a thermoplastic elastomer. A person skilled in the art will understand that further sealing materials which have water-repelling properties and which can be deformed can also be used.

The sealing element is preferably fastened to the sealing plane by adhesive bonding, plugging on or extruding on. In this case, in particular the option of extruding it on permits simple production of the sealing plane according to the invention. However, it is also conceivable for the sealing element to be fastened to the sealing plane by sealing.

### DRAWINGS

The invention is explained below with reference to drawings. These explanations are merely by way of example and do not restrict the common inventive concept.

FIG. 1 shows schematically the construction of the vehicle door according to the invention.

FIG. 2 shows schematically a sealing plane having a sealing element.

FIG. 3 shows schematically the sealing plane with elevations and depressions.

### DETAILED DESCRIPTION

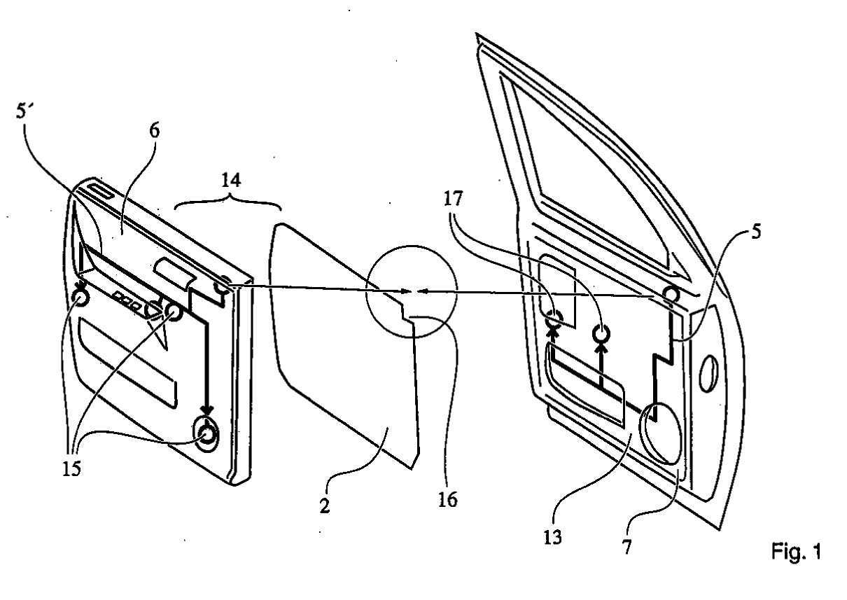

FIG. 1 illustrates schematically the construction of a vehicle door with a sealing plane 2. In the exemplary embodiment, the sealing plane 2 is fastened to an interior door molding 6. However, it is also conceivable for the interior door molding 6 and the sealing plane 2 to be manufactured as a composite part. A sealing element 3 (not illustrated in FIG. 1) is located on the rear side of the sealing plane 2 (not visible by the observer in FIG. 1). The interior door molding 6 and the sealing plane 2 can be delivered as a preassembled component and can be fitted together onto the body 7. The body 7 forms the wet region 13 of the vehicle door and can consist, for example, of an inner panel and an outer panel. The moisture located in the wet region 13 cannot spread further through the water-impermeable sealing plane 2 in the direction of the interior door molding 6. The sealing plane 2 and the interior door molding 6 therefore together form the dry region 14 of the vehicle door. The interior door molding 6 has consumers 15 for the dry region 14. In the exemplary embodiment, the consumers 15 are connected to a cable harness 5′ for the dry region 14. The body 7 has consumers 17 for the wet region 13. The consumers 17 for the wet region 13 are connected to a cable harness 5 for the wet region 13. The cable harness 5 for the wet region 13 is connected to the cable harness 5′ located in the dry region 14 by means of a transition 16 which the sealing plane 2 has. Individual connection of the consumers 15, 17 to each other is not necessary. The sealing plane 2 therefore does not have to have any holes or cutouts in which individual cables or cable harnesses 5, 5′ are guided so that a connection is produced between the wet region 13 of a vehicle door and the dry region 14 of a vehicle door.

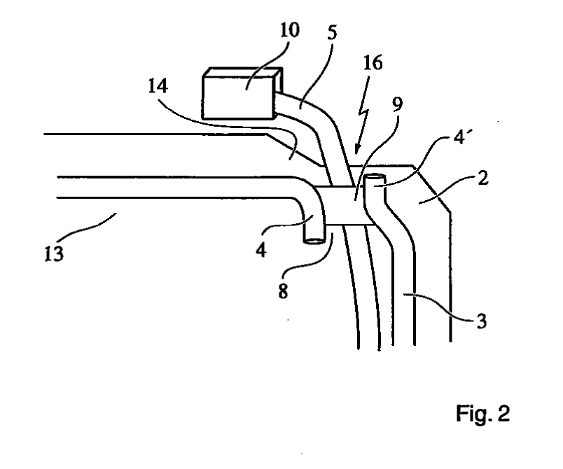

FIG. 2 shows schematically the sealing plane 2 from a side hitherto not illustrated. According to the invention, the side illustrated in FIG. 2 faces the body 7 and therefore was not visible in the previous figure (FIG. 1). The sealing plane 2 has an elongate sealing element 3, wherein the ends 4, 4′ of the sealing element 3 overlap. The ends 4, 4′ of the sealing element 3 form a type of channel 8 in which the cable harness 5 is guided. The cable harness 5 is transferred from the wet region 13 into the dry region 14 by means of the transition 16. It is therefore unnecessary, according to the invention, for the sealing plane 2 to have holes or cutouts through which a cable is guided. The cable harness 5 has a sealing sleeve 9 which is arranged annularly around the cable harness 5. The overlapping of the two ends 4, 4′ of the sealing element 3 and of the sealing sleeve 9 prevents water from penetrating into the dry region 14 of the vehicle door. Depending on the design of the sealing sleeve 9 (material and diameter of the sealing sleeve 9), compensation of tolerances in terms of the distance between the two ends 4, 4′ of the sealing element 3 can be brought about by the sealing sleeve 9. It is preferred if the sealing sleeve 9 is slightly compressed by the two ends 4, 4′. The sealing plane 2 and the sealing element 3 make it possible for parts of the cable harness 5 to be transferred from a wet region 13 into a dry region 14. The cable harness 5 is therefore preferably a wet-space cable harness, and the part which is transferred into the dry region 14 is preferably a plug 10. By means of the plug 10, the cable harness 5 can either be supplied directly with current or can be connected to another cable harness 5′ (not illustrated in FIG. 2) from the dry region 14. In both cases, electric connection of devices located in the wet region 13 is possible by means of the transfer of parts of the cable harness 5.

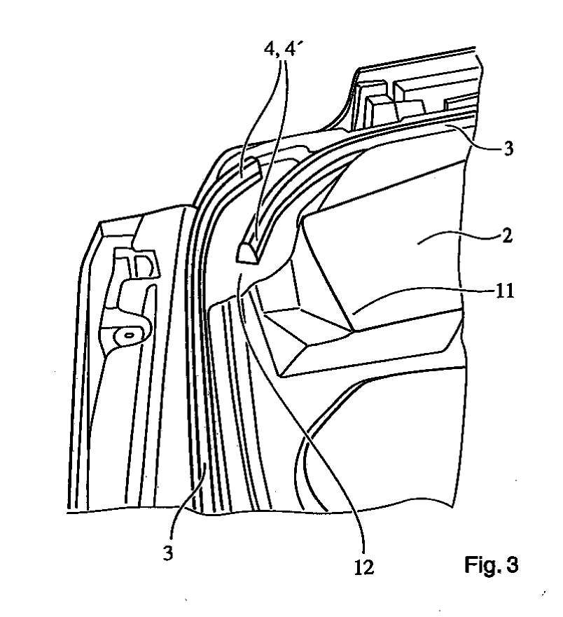

FIG. 3 shows schematically the sealing plane 2 with the sealing element 3. In this case, the sealing plane 2 has elevations 11 and depressions 12 which support the sealing element 3 and/or the cable harness 5. In this case, support is to be understood as meaning when the sealing element 3 and/or the cable harness 5 cannot slip laterally. This prevents the sealing element 3 or the cable harness 5 from being erroneously positioned.

1. A vehicle door having a sealing plane, comprising a dry region and a wet region separated from the dry region by the sealing plane, wherein the sealing plane has an elongate sealing element, wherein ends of the elongate sealing element substantially overlap, and wherein a functional element is guided between the overlapping ends of the elongate sealing element.

2. The vehicle door as claimed in claim 1, wherein in that the functional element is at least one cable.

3. The vehicle door as claimed in claim 1, wherein the sealing plane is part of an interior door molding.

4. The vehicle door as claimed in claim 1, wherein the sealing plane is substantially a continuous component without holes or cutouts.

5. The vehicle door as claimed in claim 1, wherein the sealing plane has elevations and depressions.

6. The vehicle door as claimed in claim 2, wherein the cable has a sealing sleeve.

7. The vehicle door as claimed in claim 1, wherein the overlapping ends of the sealing element are arranged in an upper region of the vehicle door.

8. The vehicle door as claimed in claim 1, wherein the sealing element, comprises foamed synthetic rubber or thermoplastic elastomer.

9. The vehicle door as claimed in claim 1, wherein the sealing element is adhesively bonded, sealed or plugged, or is extruded onto the sealing plane.
